(19) United States
(12) Patent Application Publication
(10) Pub. No.: US 2006/0208447 A1
(43) Pub. Date: Sep. 21, 2006

(54) Independent suspension for a drive axle

(75) Inventors: Edward J. Eshelman, Rochester Hills, MI (US); Christopher S. Keeney, Troy, MI (US); Christine L. Lutz, Birmingham, MI (US)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Technology, LLC

(21) Appl. No.: 11/373,470

(22) Filed: Mar. 10, 2006

Related U.S. Application Data
(60) Provisional application No. 60/663,800, filed on Mar. 21, 2005.

(51) Int. Cl. B60G 3/20

(52) U.S. Cl. 280/124.135; 280/124.157

(57) ABSTRACT

An independent suspension includes a knuckle connected to a spindle, and an upper control arm that is connected to the knuckle with a first joint assembly. A lower control arm is connected to the knuckle with a second joint assembly. The lower control arm includes a base portion, a pair of laterally extending mounting arms, and a bracket portion that extends in a vertical direction. The bracket portion includes at least two upwardly extending bracket arms that define an opening for receiving a wheel drive shaft. The wheel drive shaft defines an axis of rotation, and the bracket portion supports an air spring plate at a position directly above the axis of rotation.

### RELATED APPLICATION

This application claims priority to U.S. Provisional Application No. 60/663,800 filed on Mar. 21, 2005.

### TECHNICAL FIELD

This invention generally relates to a lower control arm for an independent suspension that includes an opening for receiving a wheel drive shaft to allow an air spring to be positioned over a laterally extending axle centerline.

### BACKGROUND OF THE INVENTION

Independent suspension systems cooperate with an axle assembly to allow each wheel to move vertically without affecting a laterally spaced opposite wheel. An independent suspension system is subjected to many packaging and design constraints. A central carrier assembly drives a pair of wheel drive shafts, which in turn drive a pair of wheels. Suspension components must be packaged around the central carrier assembly and the wheel drive shafts. These suspension components include upper and lower control arms, shock absorbers, and air springs, for example.

It is desirable to provide a spring element, such as an air spring, at a position that is near an axle centerline in order to accommodate large turning angles and to minimize the size and weight of the lower control arm. This configuration is not easily achieved with current control arm designs because current designs are completely under the drive shaft. This requires a separate bracket to support the spring, which has to be positioned to one side of the drive shaft.

For the above reasons, it would be desirable to provide a control arm configuration that can more easily accommodate an air spring above an axle centerline.

### SUMMARY OF THE INVENTION

A lower control arm for an independent suspension provides a unique configuration having an air spring bracket with an open area that receives a wheel drive shaft. The air spring bracket is adapted to support an air spring over an axle centerline defined by the wheel drive shaft.

In one example, the lower control arm includes a base portion with a pair of mounting arms extending outwardly from the base portion in a lateral direction for attachment to a vehicle structure, such as a chassis for example. The lower control arm also includes the air spring bracket that extends upwardly from the base portion. The air spring bracket includes bracket arms that are positioned at fore and aft edges of the base portion to extend vertically, upwardly from the base portion. The wheel drive shaft is positioned longitudinally between the bracket arms and extends in a lateral direction.

In one example, the base portion, the pair of mounting arms, and the bracket arms are all integrally formed together as a single piece lower control arm. In this example, the base portion, mounting arms, and bracket arms are configured to form a pyramid shape. This pyramid shape allows the wheel drive shaft to pass through the lower control arm between the bracket arms.

The bracket arms are configured to support an air spring support plate. In one example, the air spring support plate is configured to support an air spring directly above the axle centerline. This configuration provides improved maneuverability and can accommodate large turning angles. These and other features of the present invention can be best understood from the following specification and drawings, the following of which is a brief description.

### BRIEF DESCRIPTION OF THE DRAWINGS

FIG. 1 is a schematic view of a central carrier and an independent suspension assembly incorporating the subject invention.

FIG. 2 is a perspective view of the subject independent suspension system for a set of laterally spaced wheels viewed from one side of the central carrier.

FIG. 3 is a perspective of the subject independent suspension system of FIG. 2 viewed from an opposite side of the central carrier.

FIG. 4 is a perspective view of one wheel assembly associated with an independent suspension.

FIG. 5 is an end view of FIG. 4.

### DETAILED DESCRIPTION OF THE PREFERRED EMBODIMENT

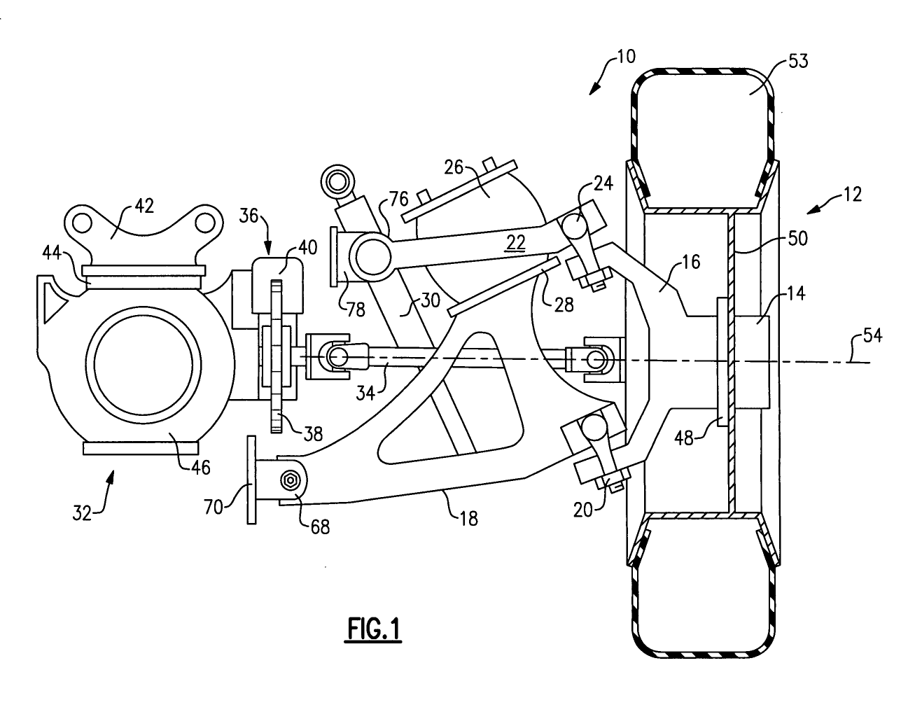

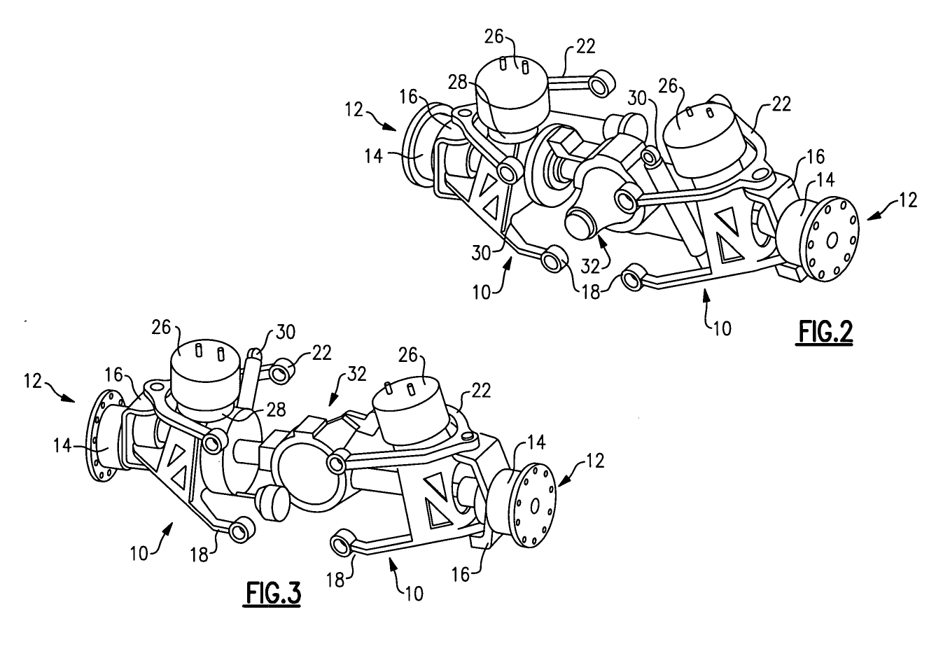

An independent suspension is shown generally at 10 in FIG. 1. The independent suspension 10 is mounted on a vehicle adjacent to a wheel assembly 12. Each wheel assembly 12 includes a separate independent suspension 10, see FIGS. 2-3, which provides for independent wheel movement at each wheel assembly 12.

As shown in FIGS. 1-3, each wheel assembly 12 includes a spindle portion 14 and a knuckle portion 16. A lower control arm 18 is attached to the knuckle portion 16 with a first ball joint assembly 20. An upper control arm 22 is attached to the knuckle portion 16 with a second ball joint assembly 24. The lower control arm 18 supports an air spring 26. The air spring 26 is supported by a spring plate 28 (FIG. 1), which is supported by the lower control arm 18. The spring plate 28 could also be formed as part of the lower control arm 18. A shock absorber 30 cooperates with the air spring 26 to accommodate variations in road surfaces as known.

As shown in FIG. 1, a central carrier assembly 32 drives a pair of wheel drive shafts 34 (only one is shown) that drive respective wheel assemblies 12. A brake assembly 36 is positioned adjacent to the central carrier assembly 32 at a position inboard from the independent suspension 10. The brake assembly 36, in the example shown in FIG. 1, comprises an air disc brake including a rotor 38 and caliper 40 at an inboard position, however other types of brakes, or other brake mounting locations could also be used. The central carrier assembly 32 is mounted to a vehicle sub-frame (not shown) as known. An optional mounting bracket 42 with elastomeric mounts 44 can be used to mount the central carrier assembly 32 to the sub-frame. The central carrier assembly 32 includes a cast bowl portion 46 that provides carrier, caliper, and sub-frame mounting interfaces.

The wheel drive shaft 34 is coupled to a wheel hub component 48 (schematically shown in FIG. 1) that supports a wheel rim 50. A tire 53 is mounted on the wheel rim 50. The wheel drive shaft 34 defines a shaft centerline 54. The shaft centerline 54 comprises an axis of rotation about which the wheel drive shaft and associated wheel assembly 12 rotates. The lower control arm 18 is uniquely configured to support the air spring 26 at a position above and near the axis of rotation.

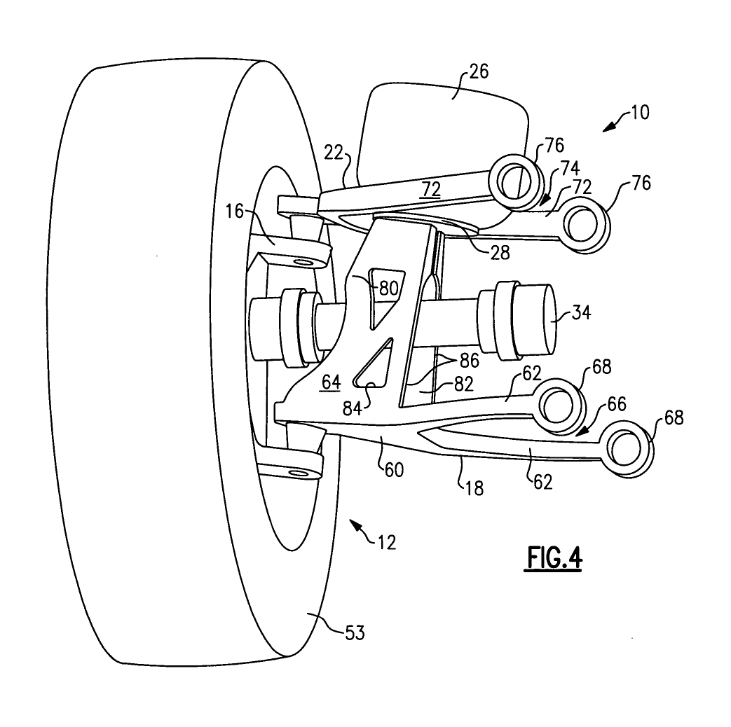

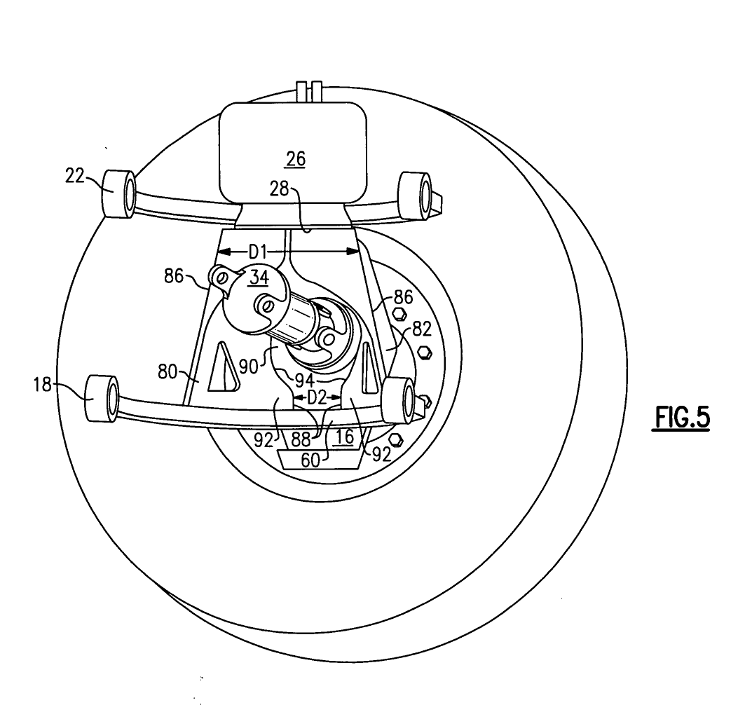

The lower control arm 18 is shown in greater detail in FIGS. 4-5. The lower control arm 18 includes a base portion 60, a pair of arms 62 extending outwardly from the base portion 60 in a lateral direction, and a bracket portion 64 extending outwardly from the base portion 60 in a vertical direction. Preferably, the base portion 60, the pair of arms 62, and the bracket portion 64 are all integrally formed together as a single piece component.

However, the base portion 60, the arms 62, and the bracket portion 64 could also be formed from multiple pieces that are attached together. This embodiment will be discussed in greater detail below. The multiple pieces for the lower control arm 18 or the integrally formed lower control arm 18 could be formed from a machine casting, stamping, or other known process. Further, the multiple pieces could be welded together, fastened together, or attached by other known joining processes. The arms 62 are spaced apart from each other to define recess portion 66. A distal end of each arm 62 includes a bushing mount 68 that is adapted to receive a bushing (not shown). The arms 62 are connected to a vehicle frame member 70 (FIG. 1) via the bushing mounts 68 as known.

The upper control arm 22 includes a pair of arms 72 that are spaced apart from each other to define recess portion 74. A distal end of each arm 72 includes a bushing mount 76 that is adapted to receive a bushing (not shown). The arms 72 are connected to a vehicle frame member 78 (FIG. 1) via the bushing mounts 76 as known.

The bracket portion 64 includes a first bracket arm 80 extending from a first edge of the base portion 60 and a second bracket arm 82 extending from an opposite edge of the base portion 60. One of the first and second edges is a fore or front edge, and the other of the first and second edges is an aft or rear edge. The first 80 and second 82 bracket arms extend upwardly from the base portion 60 toward the upper control arm 22. The first 80 and second 82 bracket arms include cut-out portions 84 to reduce weight.

As shown in FIG. 5, the first 80 and second 82 bracket arms are positioned at an oblique angle relative to the base portion 60. As shown, the first 80 and second 82 bracket arms are inclined or sloped inwardly toward each other forming a generally pyramid shape. Also, the first 80 and second 82 bracket arms extend toward the wheel assembly 12 at different angles. Each of the first 80 and second 82 bracket arms includes an inboard edge 86 that is spaced apart from an adjacent inboard edge by a first distance D1. Each of the first 80 and second 82 bracket arms includes an outboard edge 88 that is spaced apart from an adjacent outboard edge 88 by a distance D2 that is less than the first distance D1. The adjacent inboard edges 86 and the adjacent outboard edges 88 are positioned on opposite sides of the first shaft centerline 54 from each other. The first 80 and second 82 bracket arms converge toward one another along a length of the lower control arm 18 in a direction extending toward the wheel assembly 12.

The bracket portion 64 includes an opening 90 (FIG. 5) through which the wheel drive shaft 34 extends. The opening 90 is defined between the outboard edges 88 of the first 80 and second 82 bracket arms. The first 80 and second 82 bracket arms each include an inboard wall portion 92 extending inwardly toward the wheel drive shaft 34. The inboard wall portions 92 each include a recess 94 that surrounds a portion of the wheel drive shaft 34 to define the opening 90.

The spring plate 28 is either supported on or formed as part of the bracket portion 64. The spring plate 28 is supported on top edges of the first 80 and second 82 bracket arms and on top edges of the inboard wall portions 92. This configuration allows a single air spring to be positioned directly above, and centered over, the axis of rotation. This configuration improves vehicle maneuverability and can easily accommodate large turning angles.

The subject invention provides a uniquely configured lower control arm that allows an air spring to be positioned directly above a laterally extending axle centerline without adversely affecting control arm weight. This configuration improves maneuverability as large turning angles are easily accommodated.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A control arm for an independent vehicle suspension comprising:
a base portion including a first attachment interface adapted for coupling to a wheel component;
a pair of mounting arms extending outwardly from said base portion in a first direction; and
a bracket portion extending outwardly from said base portion in a second direction transverse to said first direction, said bracket portion including an opening for receiving a wheel drive shaft.

2. The control arm according to claim 1 wherein said base portion, said pair of mounting arms, and said bracket portion are all integrally formed together as a single piece component.

3. The control arm according to claim 1 wherein said first direction generally corresponds to a lateral direction extending between laterally spaced vehicle wheels and wherein said second direction generally corresponds to a vertical direction extending upwardly from said base portion.

4. The control arm according to claim 1 wherein the wheel drive shaft defines a shaft centerline extending along a length of the wheel drive shaft and wherein said base portion and said pair of mounting arms are positioned below the shaft centerline with said bracket portion extending above the shaft centerline.

5. The control arm according to claim 4 including at least one spring plate supported by said bracket portion wherein said at least one spring plate is adapted to receive a suspension spring such that the suspension spring is positioned above the shaft centerline.

6. The control arm according to claim 5 wherein said at least one spring plate comprise a single spring plate positioned to support an air spring directly over the shaft centerline.

7. The control arm according to claim 6 wherein the suspension air spring is centered over the shaft centerline.

8. The control arm according to claim 1 wherein said bracket portion comprises a first bracket arm extending upwardly from one edge of said base portion and a second bracket arm extending upwardly from an opposite edge of said base portion and wherein the wheel drive shaft is positioned directly between said first and said second bracket arms.

9. The control arm according to claim 8 wherein said first and said second bracket arms are each positioned at an oblique angle relative to said base portion.

10. The control arm according to claim 1 wherein each mounting arm of said pair of mounting arms extends to a distal end having a bushing mount adapted for attachment to a vehicle structure.

11. An independent suspension comprising:
a spindle;
a knuckle connected to said spindle;
an upper control arm connected to said knuckle with a first joint assembly;
a lower control arm connected to said knuckle with a second joint assembly, said lower control arm including a base portion, a pair of laterally extending mounting arms, and a bracket portion extending in a vertical direction wherein said bracket portion includes an opening;
a wheel drive shaft defining an axis of rotation, said wheel drive shaft adapted to transmit driving input to a wheel assembly, wherein said wheel drive shaft extends through said opening in said bracket portion; and
at least one air spring supported by a spring plate at a position vertically above said axis of rotation.

12. The independent suspension according to claim 11 wherein said at least one air spring comprises a single air spring that is supported on said spring plate a positioned directly above said axis of rotation.

13. The independent suspension according to claim 11 wherein said bracket portion comprises a first bracket arm extending upwardly from a fore edge of said base portion and a second bracket arm extending upwardly from an aft edge of said base portion and wherein said wheel drive shaft extends in a lateral direction and is positioned longitudinally between said first and said second bracket arms.

14. The independent suspension according to claim 13 wherein said first and said second bracket arms each include an inboard wall portion extending inwardly from said fore and said aft edges, respectively, toward said wheel drive shaft, and wherein said inboard wall portions each include a recess that surrounds a portion of said wheel drive shaft.

15. The independent suspension according to claim 13 wherein said first and said second bracket arms are each positioned at an oblique angle relative to said base portion.

16. The independent suspension according to claim 11 wherein each mounting arm of said pair of laterally extending mounting arms extends to a distal end having a bushing mount adapted for attachment to a vehicle structure.

17. The independent suspension according to claim 11 wherein said base portion, said pair of laterally extending mounting arms, and said bracket portion are all integrally formed together as a single piece lower control arm with said base portion and said pair of laterally extending mounting arms being positioned vertically below said axis of rotation and said bracket portion extending to an upper edge that is vertically above said axis of rotation.
